(19) United States
(12) Patent Application Publication
(10) Pub. No.: US 2009/0320594 A1
(43) Pub. Date: Dec. 31, 2009

(54) INERTIA FORCE SENSOR

(75) Inventors: Satoshi Ohuchi, Hyogo (JP); Hiroyuki Aizawa, Osaka (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/374,717

(22) PCT Filed: Aug. 20, 2007
(86) PCT No.: PCT/JP2007/066084

§ 371 Date: Jan. 22, 2009

(30) Foreign Application Priority Data
Aug. 21, 2006 (JP) 2006-223807

(51) Int. Cl. G01C 19/56

(52) U.S. Cl. 73/504.16

(57) ABSTRACT

An inertia force sensor includes a detection element having two orthogonal arms each formed by connecting one first arm orthogonally to two second arms; a support portion for supporting the two first arms; and two fixing arms connected at one end thereof to the support portion and fixed at the other end thereof to a mounting substrate. The second arms include opposing portions formed by bending the second arms to face the main portions thereof. The second arms are connected at their ends to weight parts, which include recesses to which the ends of the second arms are connected.

### TECHNICAL FIELD

The present invention relates to an angular velocity sensor for detecting angular velocity, which is used in various electronic devices for attitude control or navigation of mobile objects such as aircrafts, automobiles, robots, marine vehicles, and other vehicles.

### BACKGROUND ART

Conventional angular velocity sensors detect angular velocity by vibrating detection elements that can be formed in different shapes such as tuning-fork-shape, H-shape, or T-shape, and by electrically detecting distortions of the detection elements caused by the Coriolis force.

In a case where a vehicle is placed in the x-y plane when x, y, and z are orthogonal axes, angular velocity sensors used in a navigation system require detecting angular velocities around the x and z axes of the vehicle.

Conventionally, angular velocities of a plurality of axes (X, Y, and Z axes) are detected by using the same number of angular velocity sensors. In order to detect the angular velocity around the z axis, a detection element is arranged along the y-x plane.

Such a conventional technique related to the present invention is shown, for example, in Patent Document 1 below.

In the above structure, the detection of the angular velocities of a plurality of axes requires an electronic device to secure an area for mounting a plurality of angular velocity sensors having detection elements along the respective axes. This structure hinders the miniaturization of the electronic device in which the inertia force sensor is installed.
Patent Document 1: Japanese Patent Unexamined Publication No. 2001-208546

### SUMMARY OF THE INVENTION

An object of the present invention is to provide an angular velocity sensor which can detect angular velocities of a plurality of axes, making it unnecessary for an electronic device to secure an area for mounting a plurality of angular velocity sensors having detection elements, thereby reducing the size of the electronic device.

In the present invention, a detection element includes two orthogonal arms each formed by connecting one first arm substantially orthogonally to two second arms. The detection element further includes a support portion, two fixing arms, and weight parts. The support portion supports the two first arms. The two fixing arms are each connected to the support portion and fixed to a mounting substrate. The weight parts are connected to the ends of the four second arms. The weight parts include recesses to which the ends of the second arms are connected. The second arms are bent to face the weight parts. The weight parts are driven and vibrated in the direction in which the second arms face each other.

It is assumed that the first arms and the second arms are disposed in the x- and y-axis directions, respectively, when x, y, and z are orthogonal axes. Driving and vibrating the weight parts in the x-axis direction can make the second arms have distortions due to the angular velocities generated around the y or z axis. Detecting these distortions results in the detection of the angular velocities around the x, y, and z axes. Therefore, in order to detect angular velocities of a plurality of axes, the electronic device is not required to secure an area for mounting a plurality of angular velocity sensors having detection elements. In other words, the electronic device is only required to secure an area for mounting a single detection element, thereby being miniaturized.

### BRIEF DESCRIPTION OF THE DRAWINGS

FIG. 1 is a perspective view of a detection element of an angular velocity sensor according to an embodiment of the present invention.

FIG. 2 shows an operating condition of the detection element of the angular velocity sensor according to the embodiment of the present invention.

FIG. 3 shows changes in the resonant frequency due to the depth of recesses in weight parts and the length of the weight parts of the detection element of the angular velocity sensor according to the embodiment of the present invention.

FIG. 4 shows changes in the resonant frequency depending on where a lower electrode and a piezoelectric body are arranged on the detection element of the angular velocity sensor according to the embodiment of the present invention.

### REFERENCE MARKS IN THE DRAWINGS

1 detection element
2 first arm
4 second arm
6 support portion
8 fixing arm
9 fixing portion
10 third arm
11 weight parts
12 recess
16 opposing portion
17 first driving portion
17a first driving electrode portion
17b second driving electrode portion
18 second driving portion
18a third driving electrode portion
18b fourth driving electrode portion
19 first sensing portion
19a first sensing electrode portion
19b second sensing electrode portion
20 second sensing portion
20a third sensing electrode portion
20b fourth sensing electrode portion

### DETAILED DESCRIPTION OF PREFERRED EMBODIMENT

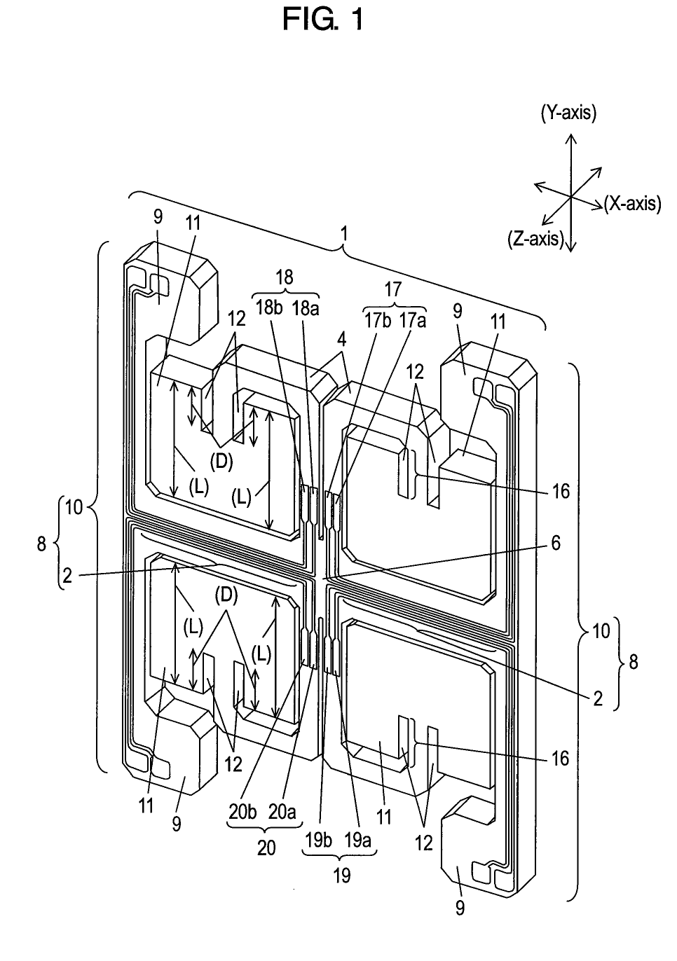

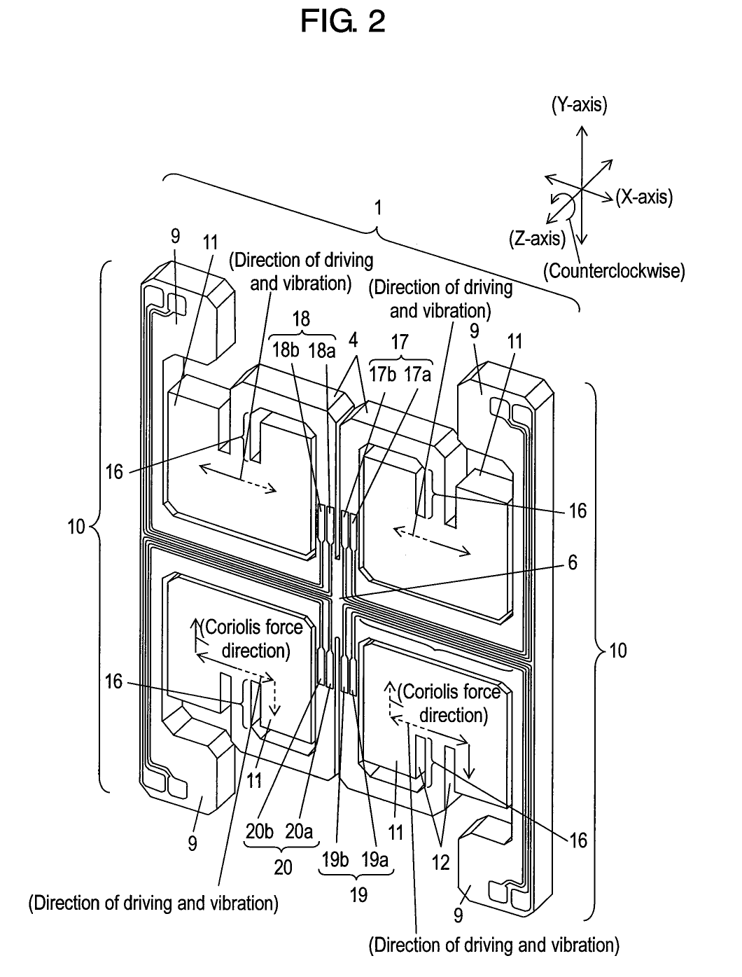

FIG. 1 is a perspective view of a detection element of an angular velocity sensor as one type of inertia force sensor according to an embodiment of the present invention. FIG. 2 shows an operating condition of the detection element of the angular velocity sensor.

As shown in FIG. 1, the angular velocity sensor includes detection element 1 for detecting angular velocity. Detection element 1 includes two orthogonal arms each formed by connecting one first arm 2 substantially orthogonally to two second arms 4. Detection element 1 further includes support portion 6 and fixing arms 8. Support portion 6 supports two first arms 2. Fixing arms 8 are orthogonal arms formed by connecting first arms 2 substantially orthogonally to third arms 10. First arms 2 and support portion 6 are arranged substantially in a straight line. First arms 2 are connected at one end thereof to support portion 6 and at the other end thereof to third arms 10. Detection element 1 is fixed to mounting substrate (not illustrated) at fixing portions 9 formed at both ends of each of third arms 10. Four fixing portions 9 may be connected so as to arrange third arms 10 in a frame shape.

Second arms 4 include opposing portions 16 formed by bending second arms 4 to face the main portions thereof, and the ends of second arms 4 are connected to weight parts 11. Weight parts 11 include recesses 12 to which the ends of second arms 4 are connected. Recesses 12 of weight parts 11 have a depth (D), which is 0.25 times to 0.4 times the length (L) of weight parts 11.

In FIG. 1, two opposite ones of four second arms 4 are provided near support portion 6 with first and second driving portions 17 and 18, respectively, for driving and vibrating weight parts 11 connected thereto. The other two opposite ones of four second arms 4 are provided near support portion 6 with first and second sensing portions 19 and 20, respectively, for detecting distortions of the two second arms 4.

First and second driving portions 17 and 18 are electrode portions for driving weight parts 11 connected to the two second arms 4. First driving portion 17 is formed of first and second driving electrode portions 17a and 17b facing each other, whereas second driving portion 18 is formed of third and fourth driving electrode portions 18a and 18b facing each other. First to fourth driving electrode portions 17a, 17b, 18a, and 18b are each formed of upper and lower electrodes (both not shown) with a piezoelectric body (not shown) interposed therebetween.

First and second sensing portions 19 and 20 are electrode portions for detecting distortions of the two second arms 4. First sensing portion 19 is formed of first and second sensing electrode portions 19a and 19b facing each other, whereas second sensing portion 20 is formed of third and fourth sensing electrode portions 20a and 20b facing each other. First to fourth sensing electrode portions 19a, 19b, 20a, and 20b are each formed of upper and lower electrodes with a piezoelectric body interposed therebetween.

First to fourth driving electrode portions 17a, 17b, 18a, and 18b, and first to fourth sensing electrode portions 19a, 19b, 20a, and 20b are produced as follows. First, a platinum (Pt) lower electrode is formed on a silicon substrate by radio frequency sputtering. Then, a lead zirconate titanate (PZT) piezoelectric body is formed on the lower electrode by radio frequency sputtering. Finally, a gold (Au) upper electrode is deposited on the PZT piezoelectric body.

FIG. 2 shows an operating condition of detection element 1 of the angular velocity sensor as one type of inertia force sensor according to the embodiment of the present invention. As shown in FIG. 2, first arms 2 and second arms 4 of detection element 1 are disposed in the x- and y-axis directions, respectively, when x, y, and z are orthogonal axes. When an AC voltage at the resonant frequency is applied to first to fourth driving electrode portions 17a, 17b, 18a, and 18b, second arms 4 start to drive and vibrate, starting from the second arms 4 that have first and second driving portions 17 and 18 thereon. Weight parts 11 also start to drive and vibrate in the direction in which second arms 4 face each other (that is, in the direction of driving and vibration shown by the solid arrows and the dotted arrows). After all, four second arms 4 and four weight parts 11 synchronously drive and vibrate in the direction in which second arms 4 face each other. The direction of driving and vibration in detection element 1 correspond to the x-axis direction.

When angular velocity is generated counterclockwise in the z axis, Coriolis force is generated synchronously with the driving and vibration of weight parts 11. The Coriolis force is generated in the direction perpendicular to the direction of driving and vibrating weight parts 11 (that is, in the Coriolis force direction shown by the solid and dotted arrows). As a result, second arms 4 can cause distortions due to the angular velocity generated counterclockwise in the z axis. The Coriolis force direction of detection element 1 corresponds to the y-axis direction.

When the Coriolis force is generated in the Coriolis force direction shown by the solid arrows, first and third sensing electrode portions 19a and 20a detect contraction of the second arms 4 that have the sensing electrode portions 19a and 20a thereon, whereas second and fourth sensing electrode portions 19b and 20b detect expansion of the second arms 4 that have the sensing electrode portions 19b and 20b thereon. On the other hand, when the Coriolis force is generated in the Coriolis force direction shown by the dotted arrows, the first to fourth sensing electrode portions detect expansion and contraction in the opposite directions. First to fourth sensing electrode portions 19a, 19b, 20a, and 20b output voltages according to the detected expansion and contraction, so that angular velocities are detected based on the output voltages.

On the other hand, when angular velocity is generated clockwise in the z axis, second arms 4 expand and contract in the opposite direction to the case where angular velocity is generated counterclockwise in the z axis. First to fourth sensing electrode portions 19a, 19b, 20a, and 20b detect the expansion and contraction, so that angular velocities are detected in the same manner as above.

When angular velocity is generated around the y axis, Coriolis force is generated synchronously with the driving and vibration of weight parts 11. The Coriolis force is generated in the direction (in the z-axis direction) perpendicular to the direction of driving and vibration of weight parts 11. As a result, second arms 4 can cause distortions due to the angular velocity generated around the y axis. First to fourth sensing electrode portions 19a, 19b, 20a, and 20b detect the expansion and contraction of second arms 4, so that angular velocities are detected.

The distortions due to the angular velocity generated around the Z or y axis are also generated in the second arms 4 that have first to fourth driving electrode portions 17a, 17b, 18a, and 18b thereon. Therefore, first to fourth sensing electrode portions 19a, 19b, 20a, and 20b can be also arranged on the second arms 4 that have first to fourth driving electrode portions 17a, 17b, 18a, and 18b.

It is assumed as described above that first arms 2 and second arms 4 are disposed in the x- and y-axis directions, respectively, when x, y, and z are orthogonal axes. Driving and vibrating weight parts 11 in the direction in which second arms 4 face each other can make second arms 4 have distortions due to the angular velocity generated around the y or z axis. Detecting these distortions results in the detection of the angular velocities around the x, y, and z axes. Therefore, in order to detect angular velocities of a plurality of axes, the electronic device is not required to secure an area for mounting a plurality of angular velocity sensors having detection elements. In other words, the electronic device is only required to secure an area for mounting a single detection element, thereby being miniaturized.

Weight parts 11 include recesses 12 to which the ends of second arms 4 are connected. Second arms 4 are bent to face weight parts 11, and weight parts 11 are driven and vibrated in the direction in which second arms 4 face each other. As a result, the drive frequency can be reduced. Weight parts 11 vibrate while dangling from second arms 4.

In general, the drive frequency is set to the resonant frequency of detection element 1, and as the resonant frequency becomes larger, the sensitivity decreases. The above structure can keep weight parts 11 dangling from second arms 4 and reduce the resonant frequency of detection element 1, thereby reducing the drive frequency of second arms 4. This makes it easy to create the topological design of the circuit, thereby improving the sensitivity.

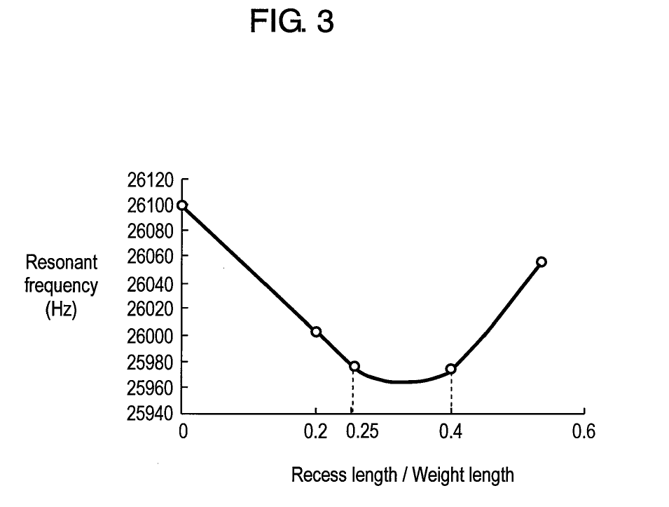

FIG. 3 shows changes in the resonant frequency due to the depth (D) of recesses 12 in weight parts 11 and the length (L) of weight parts 11 of detection element 1 of FIG. 1. As apparent from FIG. 3, the depth (D) of recesses 12 in weight parts 11 is preferably 0.25 times to 0.4 times the length (L) of weight parts 11. This is because within this range, the resonant frequency is close to its minimum. The drive frequency can be further reduced so as to improve the sensitivity by providing all the arms of detection element 1 with the lower electrode and the piezoelectric body, which are components of first and second driving portions 17, 18 and first and second sensing portions 19, 20.

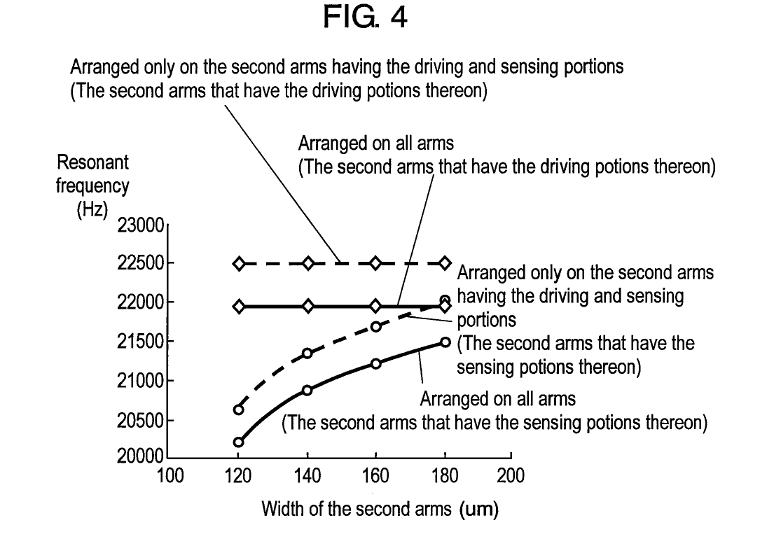

FIG. 4 shows changes in the resonant frequency of second arms 4 with respect to the width of second arms 4 in the following cases. In one case, the lower electrode and the piezoelectric body are arranged only on second arms 4 having first and second driving portions 17, 18 and first and second sensing portions 19, 20 thereon. In the other case, the lower electrode and the piezoelectric body are arranged on all the arms of detection element 1. As apparent from FIG. 4, the second arms 4 that have first and second driving portions 17, 18 thereon have a smaller resonant frequency, thereby reducing the drive frequency when the lower electrode and the piezoelectric body are arranged on all the arms of detection element 1 than when arranged only on second arms 4 having first and second driving portions 17, 18 and first and second sensing portions 19, 20 thereon.

In the same manner as above, the second arms 4 that have first and second sensing portions 19, 20 thereon have a smaller resonant frequency, thereby reducing the drive frequency when the lower electrode and the piezoelectric body are arranged on all the arms of detection element 1 than when arranged only on second arms 4 having first and second driving portions 17, 18 and first and second sensing portions 19, 20 thereon.

Reducing the width of second arms 4 results in a further reduction in the resonant frequency of the second arms 4 that have first and second sensing portions 19 and 20, thereby further reducing the drive frequency.

### INDUSTRIAL APPLICABILITY

The inertia force sensor according to the present invention can detect inertia forces of a plurality of axes, thereby being applicable to various electronic devices.

1. An inertia force sensor comprising:
a detection element for detecting an inertia force, the detection element including:
two orthogonal arms each formed by connecting a first arm orthogonally to second arms;
a support portion for supporting the two first arms;
fixing arms connected to the support portion and fixed to a mounting substrate; and
weight parts connected to ends of the second arms, wherein
the weight parts include recesses connected to the ends of the second arms; and
the second arms are bent to face the weight parts, the weight parts being driven and vibrated in a direction in which the second arms face each other.

2. The inertia force sensor of claim 1, wherein
the recesses of the weight parts have a depth which is 0.25 times to 0.4 times a length of the weight parts.

3. The inertia force sensor of claim 1, wherein
the fixing arms are orthogonal arms formed by connecting the first arms orthogonally to third arms, and
the third arms are fixed at both ends to the mounting substrate.

4. The inertia force sensor of claim 1, wherein
two opposite ones of the second arms include driving portions for driving and vibrating the weight parts;
other two opposite ones of the second arms include sensing portions for detecting distortions of the second arms; and
the driving portions and sensing portions are each formed of an upper electrode and a lower electrode with a piezoelectric body interposed therebetween.

5. The inertia force sensor of claim 4, wherein
the lower electrode and the piezoelectric body are arranged on all arms of the detection element.
